(19) United States
(12) Patent Application Publication
(10) Pub. No.: US 2025/0192899 A1
(43) Pub. Date: Jun. 12, 2025

(54) MEASUREMENT FOR CALIBRATION

(71) Applicant: Samsung Electronics Co., Ltd., Suwon-si (KR)

(72) Inventors: Md. Saifur Rahman, Plano, TX (US); Eko Onggosanusi, Coppell, TX (US); Gilwon Lee, McKinney, TX (US)

(21) Appl. No.: 18/963,138

(22) Filed: Nov. 27, 2024

Related U.S. Application Data
(60) Provisional application No. 63/608,082, filed on Dec. 8, 2023.

(51) Int. Cl. H04B 17/12; H04B 7/0417; H04B 7/06

(52) U.S. Cl. CPC H04B 17/12; H04B 7/0626; H04B 7/0417

(57) ABSTRACT

Apparatuses and methods for measurement for calibration. A method performed by a user equipment (UE) includes receiving information about K non-zero-power channel state information reference signals (NZP CSI-RSs), K>1, and a calibration report and measuring, based on the information, the K NZP CSI-RSs. The method further includes determining, based on the measurement, a calibration offset for each of the K NZP CSI-RSs and transmitting the calibration report including at least one indicator indicating the calibration offset for each of the K NZP CSI-RSs. Each of the K NZP CSI-RSs is associated with a CSI-RS port. The calibration offset corresponds to at least one of a delay offset (DO), a frequency offset (FO), and a phase offset (PO).

### CROSS-REFERENCE TO RELATED AND CLAIM OF PRIORITY

The present application claims priority under 35 U.S.C. § 119(e) to U.S. Provisional Patent Application No. 63/608,082 filed on Dec. 8, 2023, which is hereby incorporated by reference in its entirety.

### TECHNICAL FIELD

The present disclosure relates generally to wireless communication systems and, more specifically, the present disclosure is related to apparatuses and methods for measurement for calibration.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to measurement for calibration.

In one embodiment, a user equipment (UE) is provided. The UE includes a transceiver configured to receive information about (i) K non-zero-power channel state information reference signals (NZP CSI-RSs), K>1, and (ii) a calibration report. The UE further includes a processor operably coupled to the transceiver. The processor is configured to measure, based on the information, the K NZP CSI-RSs and determine, based on the measurement, a calibration offset for each of the K NZP CSI-RSs. The transceiver is further configured to transmit the calibration report including at least one indicator indicating the calibration offset for each of the K NZP CSI-RSs. Each of the K NZP CSI-RSs is associated with a CSI-RS port. The calibration offset corresponds to at least one of a delay offset (DO), a frequency offset (FO), and a phase offset (PO).

In another embodiment, a BS is provided. The BS includes a processor and a transceiver operably coupled to the processor. The transceiver is configured to transmit information about K NZP CSI-RSs, K>1, and a calibration report and receive the calibration report including at least one indicator indicating a calibration offset for each of the K NZP CSI-RSs. Each of the K NZP CSI-RSs is associated with a CSI-RS port. The calibration offset corresponds to at least one of a DO, a FO, and a PO.

In yet another embodiment, a method performed by a UE is provided. The method includes receiving information about K NZP CSI-RSs, K>1, and a calibration report and measuring, based on the information, the K NZP CSI-RSs. The method further includes determining, based on the measurement, a calibration offset for each of the K NZP CSI-RSs and transmitting the calibration report including at least one indicator indicating the calibration offset for each of the K NZP CSI-RSs. Each of the K NZP CSI-RSs is associated with a CSI-RS port. The calibration offset corresponds to at least one of a DO, a FO, and a PO.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of example physical layer functionality split according to embodiments of the present disclosure;

FIG. 11 illustrates a diagram of an antenna port layout according to embodiments of the present disclosure;

FIG. 12 illustrates examples of a UE moving on a trajectory with antenna groups (AGs)/port groups (PGs) of the BS co-located and distributed located according to embodiments of the present disclosure;

FIG. 13 illustrates a diagram of an example system for measurement and reporting according to embodiments of the present disclosure;

FIG. 14 illustrates a diagram of an example system for measurement and reporting according to embodiments of the present disclosure;

FIG. 15 illustrates a diagram of an example system for measurement and reporting according to embodiments of the present disclosure;

FIG. 16 illustrates a diagram of example downlink (DL) bandwidth part (BWP) resources according to embodiments of the present disclosure; and

FIG. 17 illustrates an example method performed by a UE in a wireless communication system according to embodiments of the present disclosure.

### DETAILED DESCRIPTION

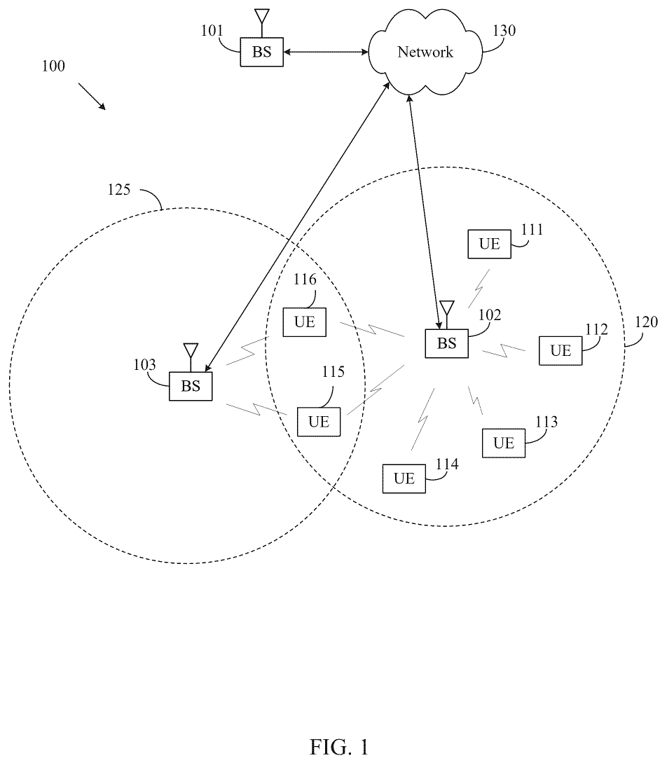

FIGS. 1-17 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1]3GPP TS 36.211 v17.3.0, “E-UTRA, Physical channels and modulation;” [REF2]3GPP TS 36.212 v17.3.0, “E-UTRA, Multiplexing and Channel coding;” [REF 3]3GPP TS 36.213 v17.3.0, “E-UTRA, Physical Layer Procedures;” [REF 4]3GPP TS 36.321 v17.3.0, “E-UTRA, Medium Access Control (MAC) protocol specification;” [REF 5]3GPP TS 36.331 v17.3.0, “E-UTRA, Radio Resource Control (RRC) Protocol Specification;” [REF 6]3GPP TR 22.891 v1.2.0; [REF 7]3GPP TS 38.212 v18.0.0, “E-UTRA, NR, Multiplexing and Channel coding;” [REF 8]3GPP TS 38.214 v18.0.0, “E-UTRA, NR, Physical layer procedures for data;” [REF 9]3GPP TS 38.211 v18.0.0, “E-UTRA, NR, Physical channels and modulation;” [REF 10]3GPP TS 38.104 v18.3.0, “E-UTRA, NR, Physical channels and modulation;” [REF 11]O-RAN.WG4.CONF.0-R003-v09.00, “O-RAN Working Group 4 (Fronthaul Working Group) Conformance Test Specification;” and [REF 12]O-RAN.WG4.CUS.0-R003-v13.00, “O-RAN Working Group 4 (Open Fronthaul Interfaces WG)—Control, User and Synchronization Plane Specification.

FIGS. 1-17 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing measurement for calibration. In certain embodiments, one or more of the BSs 101-103 include circuitry, programing, or a combination thereof to support measurement for calibration.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

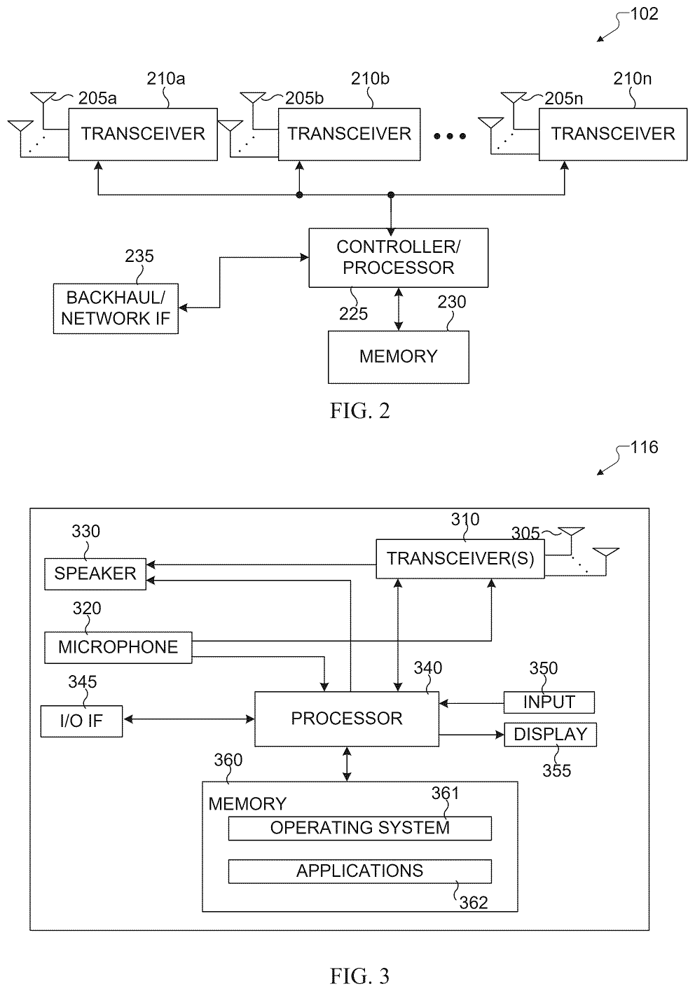

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for measurement for calibration. Any of a wide variety of other functions could be supported in the gNB 102 by the controller/processor 225.

The controller/processor 225 is also capable of executing programs and other processes resident in the memory 230, such as processes to support measurement for calibration. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for measurement for calibration as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

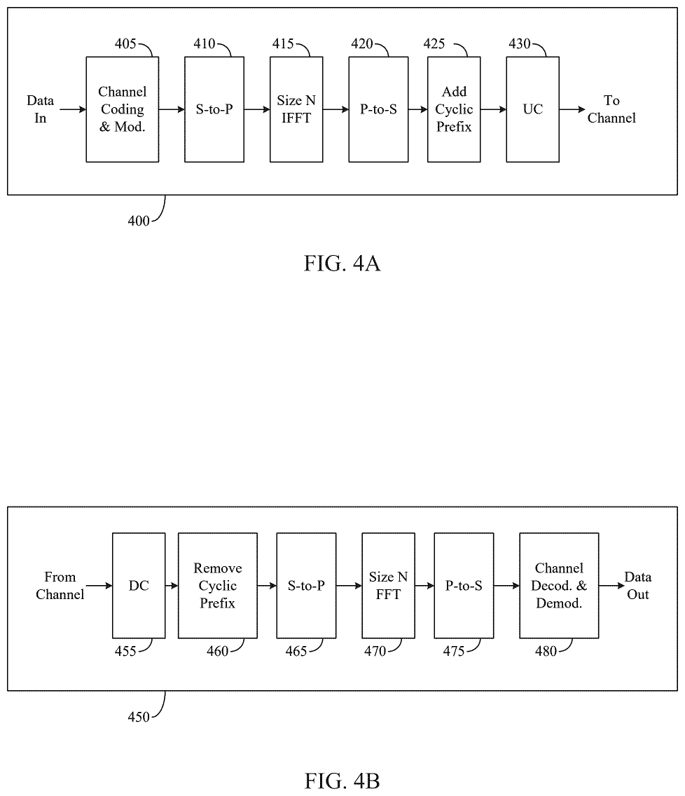

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for measurement for calibration as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The P-to-S block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

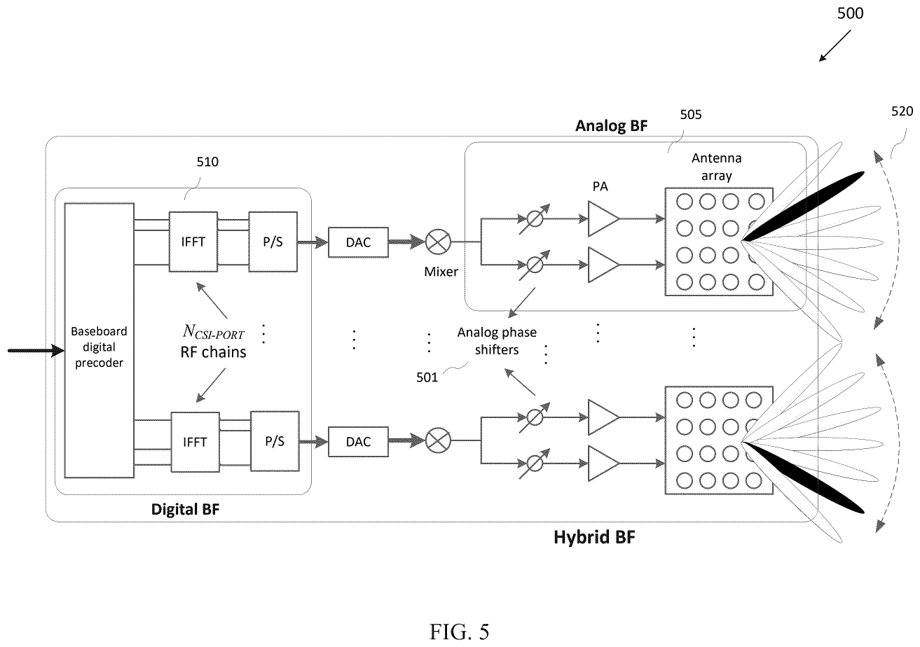

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCS-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

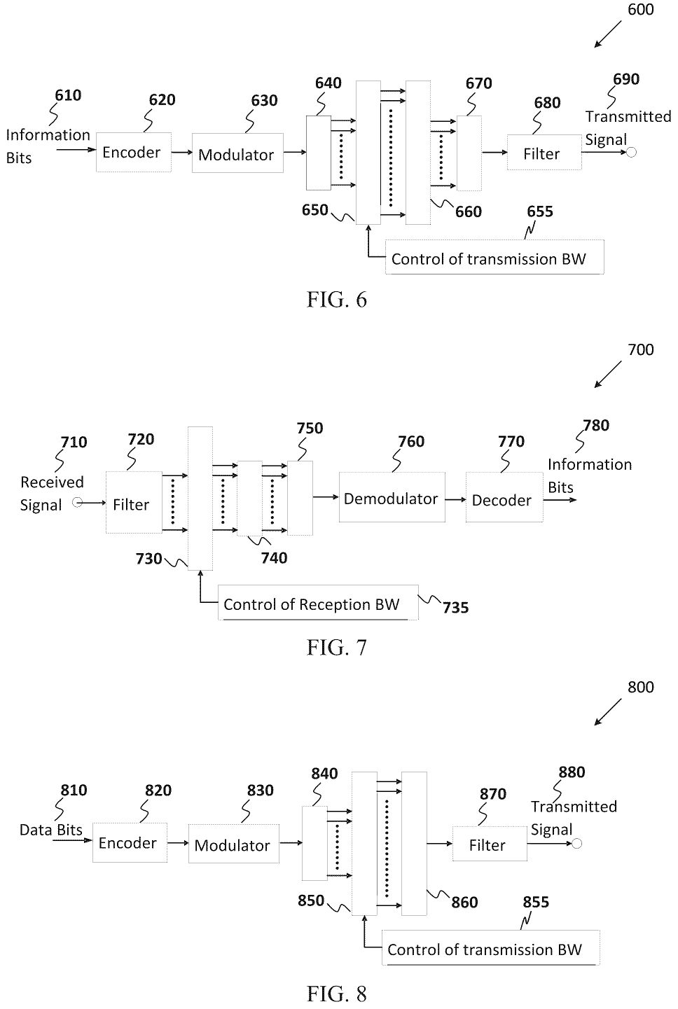

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

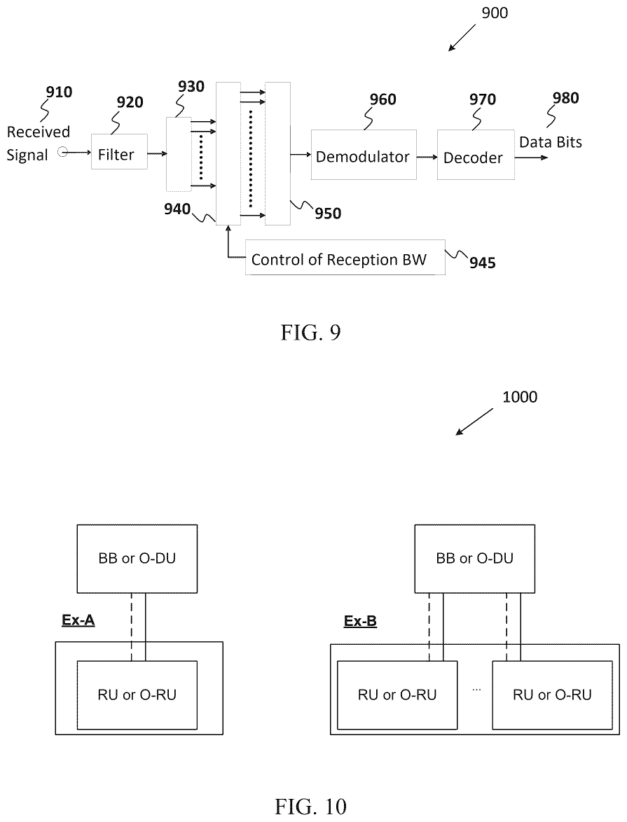

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

The present disclosure relates generally to wireless communication systems and, more specifically, to measurement for antenna calibration.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB) or gNodeB (gNB), which is generally a fixed station, may also be referred to as an access point or other equivalent terminology. For LTE systems, a NodeB is often referred to as an eNodeB. For NR systems, a NodeB is often referred to as an gNodeB.

In a communication system, such as NR or LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS for time/frequency tracking (aka CRS in LTE or TRS in NR), for CSI reporting. DMRS can be transmitted only in the BW of a respective PDSCH, and a UE can use the DMRS to demodulate data or control information in a PDSCH or a PDCCH, respectively. A transmission time interval for DL channels is referred to as a subframe or slot and can have, for example, duration of 1 millisecond or a value depending on the subcarrier-spacing (SCS).

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF 3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical Resource Blocks (PRBs). A transmission BW includes frequency resource units referred to as Resource Blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH} M_{PDSCH}·N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data transport block (TB) in a PDSCH or absence of a PDCCH detection (DTX), Scheduling Request (SR) indicating whether a UE has data in its buffer, and Channel State Information (CSI) enabling an eNB/gNB to perform link adaptation for PDSCH transmissions to a UE. HARQ-ACK information is also transmitted by a UE in response to a detection of a PDCCH indicating a release of semi-persistently scheduled PDSCH (see also REF 3).

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. A last few subframe (or slot) symbols can be used to multiplex SRS transmissions from one or more UEs.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range designation | Corresponding frequency range |
|---|---|
| FR1 | 450 MHz-600 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW (e.g., the network 130) deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of radio RF/hardware (HW)-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed regarding carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiuser MIMO (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in the future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to the distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE.

In 5G or NR systems [REF7, REF8], both low-(aka Type I) and high-resolution (aka Type II) CSI reporting mechanisms are supported. In addition, to reduce Type II CSI reporting, a frequency domain (FD) compression based Type II CSI is also supported, which is based on (a) spatial domain (SD) basis W₁, (b) FD basis W_{f}, and (c) coefficients \tilde{W}₂ that linearly combine SD and FD bases. For a (full TDD or partial FDD) reciprocity, CSI-RS ports can be beamformed (using SRS measurements, assuming UL-DL channel reciprocity in angular/delay), and the SD basis corresponds to a port selection basis.

In Rel. 18, the FD-compression-based Type II CSI is further enhanced for the use case of CJT across up to 4 TRPs, under the idealistic assumptions such as perfectly time and frequency synchronized mTRPs, phase-coherent antenna ports and ideal backhaul links. In practice, however, these assumptions are not valid. Embodiments of the present disclosure recognize that calibration/synchronization across TRPs is necessary in order to make CJT feasible.

Massive MIMO base stations or TRPs use an on-board coupling network and calibration circuits, referred to as the on-board calibration for brevity, to measure the gain and phase differences among transceivers in the same radio frequency (RF) unit in order to maintain the reciprocity between DL and UL channels, in the TDD system in particular. For the on-board calibration, one RF chain corresponding to one antenna port serves as a reference to other RF chains for other antenna ports. In the case of the mTRP system, such reference transceiver's signal needs to be shared between distributed RRHs/panels/modules/TRPs, which are physically far apart or non-co-located. Using RF cables to distribute the reference is not preferable as it limits the deployment scenarios. In addition, the use of different local oscillators (LOs) between distributed antenna modules imposes even more challenges in achieving calibration as the phase of LOs could drift. Periodic calibration is needed to compensate for the phase drift as well.

Issue 1: In one example, the timing offset can be expressed as Tₜ=e^{j2π(t+Δt)}, where Δt is due to timing difference between (distributed, non-co-located) TRPs or/and different propagation delays from different TRPs, which amounts to increased frequency-selectivity of the composite channel. The min freq. granularity (supported in NR) is 2 RBs (for precoding matrix indicator (PMI)) and 4 RBs (channel quality indicator (CQI)), which correspond to a max delay spread 2.8 and 1.4 microsecond for SCS=15 and 30 kHz, respectively. This delay spread decreases further with increasing freq. granularity (due to timing offset). For large delay spread (e.g. X×CP, X=scaling and CP=CP length in seconds), the required freq. granularity for CJT (across TRPs) will be smaller than 2 RBs (e.g. density=1 per RB or even <1 per RB). According to [REF10] TS 38.104, the min timing error=65 ns.

TABLE 0.5
(Table 9.6.1.3-1: OTA frequency error minimum requirement)

| BS class | Accuracy | |
|---|---|---|
| Wide Area BS | ±0.05 | ppm |
| Medium Range BS | ±0.1 | ppm |
| Local Area BS | ±0.1 | ppm |

Issue 2: In one example, the frequency offset can be expressed as T_{f}=e^{j2π(f+Δf)t}, where Δf is due to non-ideal (and can be different) local oscillators or crystal types at different TRPs, which results in frequency differences between TRPs. As shown herein, the min freq. error=0.05 ppm, according to [REF10] TS 38.104. The phase change due to freq. error can be significant, especially at higher carrier frequencies.

In general, the combined (time-frequency) T-F offset can be expressed as T_{t,f}=e^{j2π(f+Δf)(t+Δt)}. For CJT feasibility, (Δt, Δf) needs to be calibrated frequently.

Issue 3: non-ideal backhaul links between TRPs, especially when the backhaul links are not fiber-optic cables.

Issue 4: phase-coherency across antenna ports, both intra-TRP (within each TRP) and inter-TRP (across TRPs), but mainly inter-TRP (if intra-TRP phase coherency can be achieved by implementation, e.g. over-the-air measurement from 1 port to >=1 ports at the same TRP).

In this disclosure, the mechanism are procedures are provided for Issues 1 and 2, which are more severe than Issues 3 and 4.

FIG. 10 illustrates a diagram of example physical layer functionality split 1000 according to embodiments of the present. For example, the physical layer functionality split 1000 can be implemented by the BS 103 of FIG. 1. This example is for illustration only and other embodiments can be used without departing from the scope of the present disclosure.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, or a cell group.

Likewise, for O-RAN, a TRP can be functionally equivalent to (hence can be replaced with) or is interchangeable with one of more of the following:
One receiver unit (RU) or O-RU: a logical node that includes a subset of the eNB/gNB functions (e.g. as listed in clause 4.2 split option 7−2x)
More than one RUs or O-RUs
One or more than one RUs or O-RUs

With reference to FIG. 10, two examples are shown.

The following are defined in [REF11] and [REF12].
O-CU O-RAN Central Unit—a logical node hosting packet data convergence protocol (PDCP), RRC, service data adaptation protocol (SDAP) and other control functions
O-DU O-RAN Distributed Unit: a logical node hosting RLC/MAC/High-PHY layers based on a lower layer functional split. O-DU in addition hosts an M-Plane instance.
O-RU O-RAN Radio Unit: a logical node hosting Low-PHY layer and RF processing based on a lower layer functional split. This is similar to 3GPP's “TRP” or “RRH” but more specific in including the Low-PHY layer (FFT/iFFT, physical random access channel (PRACH) extraction).>. O-RU in addition hosts M-Plane instance.

This disclosure provides over-the-air (OTA) signaling mechanism for calibration among multiple TRPs or RRHs. The mechanism includes 1) DL RS (e.g. CSI-RS) transmission from mTRPs and measurement (by the UE) and 2) reporting related to the calibration information (e.g. amp/phase of calibration coefficients). The aspects provided are as follows:
Measurements (DL RS) needed for time/frequency/phase offset calibration, e.g. CSI-RS density, number of CSI-RS resources
Measurement assuming decoupled (separate) time and frequency calibration
Measurement assuming coupled (joint) time and frequency calibration

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), O-RAN, and so on.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are provided as the duplex method for both DL and UL signaling. Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI or calibration coefficient reporting setting.

“CSI or calibration coefficient reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”.

The term “CSI or calibration coefficient reporting band” is used only as an example for representing a function. Other terms such as “CSI or calibration coefficient reporting subband set” or “CSI or calibration coefficient reporting bandwidth” can also be used.

In terms of UE configuration, a UE can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g. via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

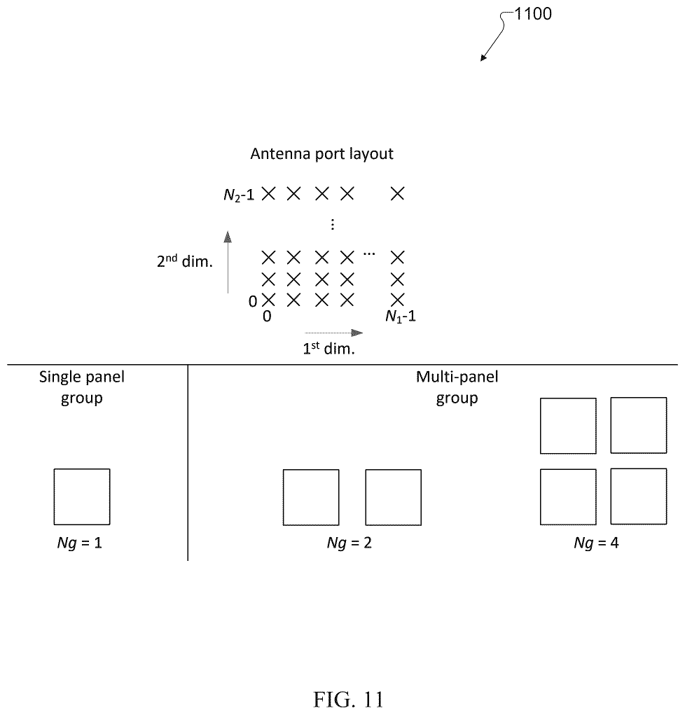

FIG. 11 illustrates a diagram of an antenna port layout 1100 according to embodiments of the present disclosure. For example, antenna port layout 1100 can be implemented by the BS 102 of FIG. 2. This example is for illustration only and can be used without departing from the scope of the present disclosure.

In the following, N₁ and N₂ are regarded as the number of antenna ports with the same polarization in the first and second dimensions, respectively. For 2D antenna port layouts, N₁>1, N₂>1, and for 1D antenna port layouts N₁>1 and N₂=1 (or N₁=1 and N₂>1) are provided. For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. With reference to FIG. 11, “X” representing two antenna polarizations is shown. In this disclosure, the term “polarization” refers to a group of antenna ports with the same polarization. For example, antenna ports

$$X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 ,$$

comprise a second antenna polarization, where P_{CSIRS} is a number of CSI-RS antenna ports and X is a starting antenna port number (e.g. X=3000, then antenna ports are 3000, 3001, 3002, . . . ). Dual-polarized antenna layouts are expected in this disclosure. The embodiments (and examples) in this disclosure, however, are general and are applicable to single-polarized antenna layouts as well.

Let N_{g} be a number of antenna groups (AGs) or port groups (PGs), where a port can be a logical mapping (node) to one antenna (1-on-1 mapping) or multiple antennae (one-on-multiple mapping). When there are multiple antenna groups (N_{g}>1), each group (g∈{1, . . . , N_{g}}) comprises dual-polarized antenna ports with N_{1,g} and N_{2,g} ports in two dimensions. With reference to FIG. 11, this is shown. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g} (for co-polarized or dual-polarized respectively).

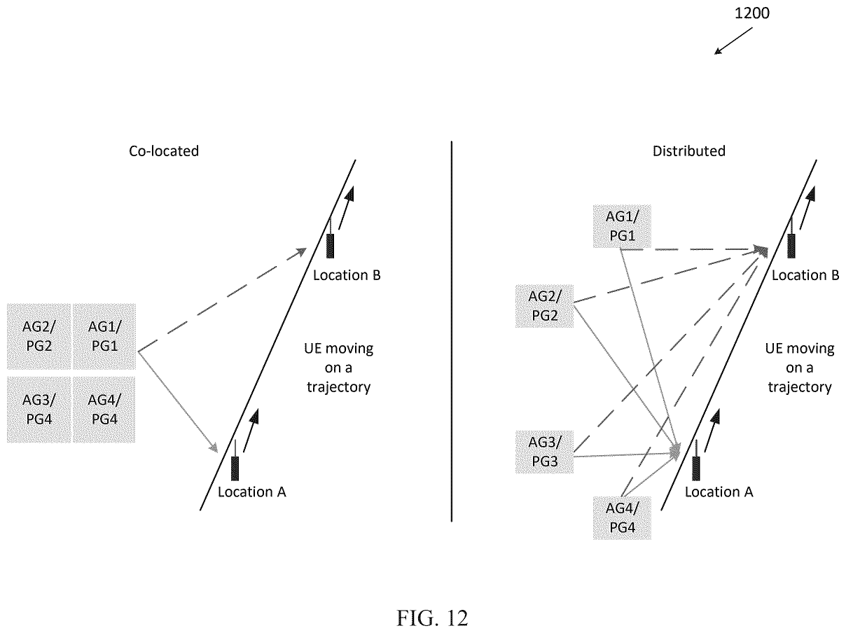

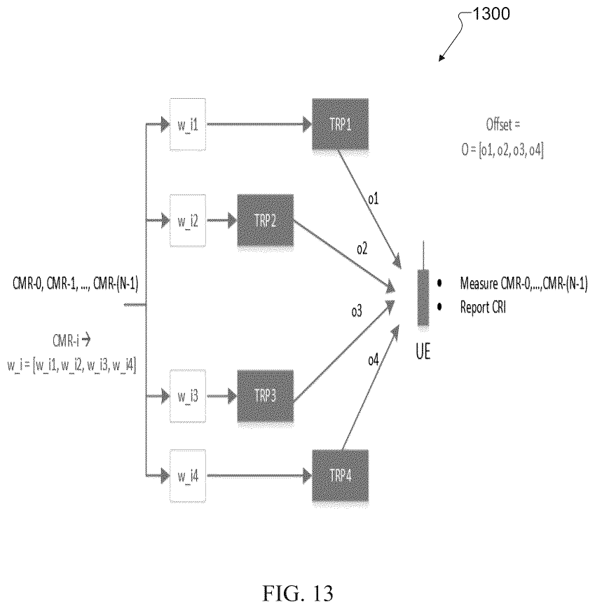

FIG. 12 illustrates examples of a UE moving on a trajectory 1200, with AGs/PGs of the BS co-located and distributed according to embodiments of the present disclosure. For example, trajectory 1200, with AGs of the BS co-located and distributed, can be implemented by any of the UEs 111-116 of FIG. 1. This example is for illustration only and can be used without departing from the scope of the present disclosure.

In one example, an antenna group corresponds to an antenna panel. In one example, an antenna group corresponds to a TRP. In one example, an antenna group corresponds to an RRH. In one example, an antenna group corresponds to CSI-RS antenna ports of a non-zero power (NZP) CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g. comprising a CSI-RS resource set).

In one example, an antenna group corresponds to a reconfigurable intelligent surface (RIS) in which the antenna group can be (re-)configured more dynamically (e.g. via MAC CE or/and DCI). For example, the number of antenna ports associated with the antenna group can be changed dynamically.

In one example scenario, multiple AGs/PGs can be co-located or distributed, and can serve static (non-mobile) or moving UEs. With reference to FIG. 12, AGs/PGs serving a moving UE is shown in. While the UE moves from a location A to another location B, the UE measures the channel, e.g. via NZP CSI-RS resources, (may also measure the interference, e.g. via CSI interference measurement (CSI-IM) resources or CSI-RS resources for interference measurement), uses the measurement to determine/report CSI or calibration-related information regarding joint transmission from multiple AGs/PGs.

In one example, the antenna architecture of the MIMO system is structured. For example, the antenna structure at each AG/PG is dual-polarized (single or multi-panel as shown in FIG. 11). The antenna structure at each AG/PG can be the same. Or the antenna structure at an AG/PG can be different from another AG/PG. Likewise, the number of ports at each AG/PG can be the same. Or the number of ports at one AG/PG can be different from another AG/PG.

In another example, the antenna architecture of the MIMO system is unstructured. For example, the antenna structure at one AG/PG can be different from another AG/PG.

A structured antenna architecture is expected in the rest of the disclosure. For simplicity, each AG/PG is equivalent to a panel (cf. FIG. 11), although, an AG/PG can have multiple panels in practice. The disclosure however is not restrictive to a single panel assumption at each AG/PG, and can easily be extended (covers) the case when an AG/PG has multiple antenna panels.

In one embodiment, an AG/PG constitutes (or corresponds to or is equivalent to) at least one of the following:
In one example, an AG/PG corresponds to a TRP.
In one example, an AG/PG corresponds to a CSI-RS resource. A UE (e.g., the UE 116) is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein in this disclosure.
In one example, an AG/PG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG/PG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG/PG. The information about the subsets of ports or grouping of ports can be provided together with the CSI-RS resource setting/configuration, or with the CSI reporting setting/configuration, or with the CSI-RS resource configuration.
In one example, an AG/PG corresponds one or more examples described herein depending on a configuration. For example, this configuration can be explicit via a parameter (e.g. an RRC parameter), or it can be implicit.
   In one example, when implicit, it could be based on the value of K. For example, when K>1 CSI-RS resources, an AG/PG corresponds to one or more examples described herein, and when K=1 CSI-RS resource, an AG/PG corresponds to one or more examples described herein.
   In another example, the configuration could be based on the configured codebook. For example, an AG/PG corresponds to a CSI-RS resource (according to one or more examples described herein) or resource group (according to one or more examples described herein) when the codebook corresponds to a decoupled codebook (modular or separate codebook for each AG/PG), and an AG/PG corresponds to a subset (or a group) of CSI-RS ports (according to one or more examples described herein) when codebook corresponds to a coupled (joint or coherent) codebook (one joint codebook across AGs).

In one example, when AG/PG maps (or corresponds to) a CSI-RS resource or resource group (according to one or more examples described herein), and a UE can select a subset of AGs/PGs (resources or resource groups) and report the CSI or calibration-related information for the selected AGs/PGs (resources or resource groups), the selected AGs/PGs can be reported via an indicator (e.g. via UCI part 1 of a two-part UCI). For example, the indicator can be a CSI-RS resource indicator (CRI) or a PMI (component) or a new indicator (e.g. a bitmap).

In one example, when AG/PG maps (or corresponds to) a CSI-RS port group (according to one or more examples described herein), and a UE can select a subset of AGs/PGs (port groups) and report the CSI or calibration-related information for the selected AGs/PGs (port groups), the selected AGs/PGs can be reported via an indicator (e.g. via UCI part 1 of a two-part UCI). For example, the indicator can be a CRI or a PMI (component) or a new indicator (e.g. a bitmap).

In one example, CSI-RS herein in this disclosure comprises at least one or a combination of the following: CSI-RS for tracking (TRS), CSI-RS for CSI, CSI-RS for beam management (BM), CSI-RS for mobility or NZP CSI-RS resource for IMR (interference measurement) or a new type/usage of CSI-RS, namely, CSI-RS for calibration.

In one embodiment, a UE is configured with a calibration mechanism, wherein the UE is configured to perform one or more UL RS transmission(s), and/or to perform one or more DL RS reception(s)/measurement(s), and/or to report calibration-related information (e.g., for calibration coefficient for each TRP).

This configuration can be performed via higher-layer (RRC) signaling.
In one example, this configuration corresponds to a CSI resource setting configured via a higher layer IE CSI-ResourceConfig.
In one example, this configuration corresponds to a CSI resource set configured via a higher layer IE NZP-CSIRSResourceSet.
In one example, this configuration corresponds to a NZP CSI resource configured via a higher layer IE NZP-CSIRSResource.
In one example, this configuration corresponds to a CSI report setting configured via a higher layer IE CSI-ReportConfig.

In one example, the DL RS(s) can be one of or multiple of CSI-RS for CSI reporting, CSI-RS for tracking (TRS), CSI-RS for beam reporting, DL DMRS, or synchronization signal block (SSB)/physical broadcast channel (PBCH) or a new type/usage of CSI-RS, namely, CSI-RS for calibration. In one example, DL RS can be a dedicated or new DL RS (for calibration purpose).

In one example, the UL RS(s) can be one of or multiple of SRS with usage=CB, SRS with usage=non-CB, SRS with usage=beamManagement, SRS with usage=AntennaSwitching, or UL DMRS. In one example, UL RS can be a dedicated or new UL RS (for calibration purpose).

In one example, the DL RS(s) can be aperiodic (AP) only. In one example, the DL RS(s) can be AP or semi-persistent (SP). In one example, the DL RS(s) can be AP or periodic (P). In one example, the DL RS(s) can be SP or P. In one example, the DL RS(s) can be AP or SP or P.

In one example, the UL RS(s) can be aperiodic (AP) only. In one example, the UL RS(s) can be AP or semi-persistent (SP). In one example, the UL RS(s) can be AP or periodic (P). In one example, the UL RS(s) can be SP or P. In one example, the UL RS(s) can be AP or SP or P.

In one example, the reporting can only be AP. In this case, the reporting can be triggered via a DCI (e.g. a CSI request field in UL-DCI). In one example, the reporting can either be AP or SP. For AP, the reporting can be triggered via a DCI (e.g. a CSI request field in UL-DCI), and for SP, it can be triggered via MAC CE or DCI.

In one example, the reporting can only be UE-initiated (or UE-triggered). In this case, the reporting can be triggered via UL MAC CE (e.g. MAC control unit (CE) for power headroom report (PHR) reporting) or via a pre-notification message sent by the UE, where this message can be sent via SR (scheduling request) or via UCI (a pre-configured PUCCH or a PUSCH).

The term ‘precoder’ in this disclosure can be replaced with a spatial information (or transmission configuration indication (TCI) state, or spatialRelationInfo) or source RS or spatial filter, beamformer, beamforming vectors/matrices, precoding vector/matrices, or any other functionally equivalent quantity, that can be used for DL/UL RS reception/transmission.

In this disclosure, a resource or a measurement resource is functionally equivalent to (hence can be replaced with) (a) one or more than one antenna port (AG/PG); and (b) associated parameters (e.g. similar to parameters of a CSI-RS resource).

FIG. 13 illustrates a diagram of an example system 1300 for measurement and reporting according to embodiments of the present disclosure. For example, system 1300 for measurement and reporting can be implemented by the UE 116 and the gNB 102 and/or network 130 in the wireless network 100 of FIG. 1. This example is for illustration only and other embodiments can be used without departing from the scope of the present disclosure.

In one embodiment, a UE is configured with a measurement and a report (e.g. CSI report), as described herein, based on Scheme 1 (shown in FIG. 13).

Let oᵣ denote the actual offset for r-th TRP, where oᵣ=(Δtᵣ, Δfᵣ) or only Δtᵣ, or only Δfᵣ.

For measurement, the ULE is configured with Z≥1 channel measurement resources (CMRs) such as NZP CSI-RS resources, or SSBs, or other DL RSs.

In one example, each CMR is a 1-port resource.

In one example, Z=N. In one example, Z=Nₜᵣₚ. In one example, Z=aN or aNₜᵣₚ where a≥1.

Each CMR-i can be associated with (or linked to) a candidate offset value o_{i,r}=(δt_{i,r}, δf_{i,r}) or calibration coefficient w_{i,r} for TRP r=1, . . . , N.

The report can also include additional information.
In one example, the additional information includes a value of M, where M=0 corresponds to a NCJT hypothesis and M>0 corresponds to a CJT hypothesis.
In one example, the additional information includes a metric such as reference signal received power (RSRP), signal-to-interference-plus-noise ratio (SINR), or CQI or block error ratio (BLER) or auto-/cross-correlation.

In one example, the UE is configured with S>1 sets of CMRs or S>1 groups of CMRs in one set, each set or group corresponds to (or associated with) a TRP. The report includes n≥1 groups of CRIs, each group comprising N CRIs.

In an alternate design, each CMR can be further configured with a higher layer parameter repetition. When repetition is set to ON, the UE can perform Rx tuning.

In an alternate design, Z=1 and the CMR is configured with repetition, where the number of repetitions=the number of candidate offset values.

In one example, the UE can also be indicated with some information about the candidate offset values o_{i,r}=(δt_{i,r}, δf_{i,r}) or calibration coefficients w_{i,r} or the corresponding measurement RS. This indication can be dynamic via DCI (DL-DCI or UL-DCI), or MAC CE, or RRC.

In one example, the UE is indicated with an indication about the offsets or calibration coefficients for CJT transmission.

In one example, this indication is based on the beam indication mechanism. In particular, a quasi-co-location (QCL)-type or a new QCL-Info or a new TCI state definition can be introduced/specified to enable the calibration process.

The indication could also include an information about the coherence hypotheses, CJT or/and NCJT. For example, when v=0, NCJT; and v>0, CJT (may also include a value).

In one example, a new spec entity can be introduced for the calibration process.

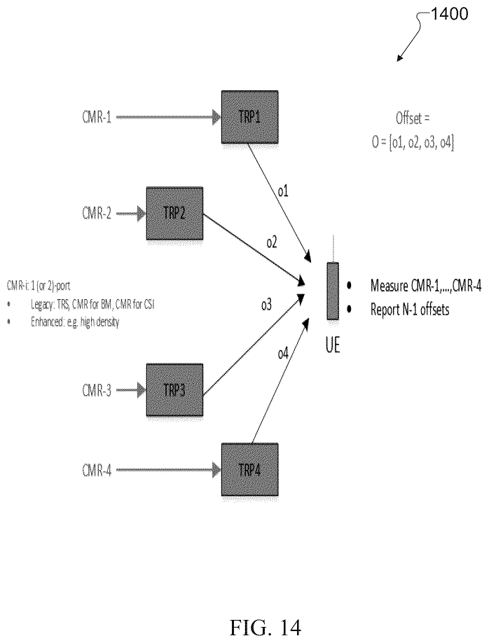

FIG. 14 illustrates a diagram of an example system 1400 for measurement and reporting according to embodiments of the present disclosure. For example, system 1400 for measurement and reporting can be implemented by the UE 116 and the gNB 103 and/or network 130 in the wireless network 100 of FIG. 1. This example is for illustration only and other embodiments can be used without departing from the scope of the present disclosure.

In one embodiment, a UE is configured with a measurement and a report (e.g. CSI report), as described herein, based on Scheme 2 (shown in FIG. 14).

Let oᵣ denote the actual offset for r-th TRP, where oᵣ=(Δtᵣ, Δfᵣ) or only Δtᵣ or only Δfᵣ.

For measurement, the UE is configured with Z≥1 channel measurement resources (CMRs) such as NZP CSI-RS resources, or SSBs, or other DL RSs. In one example, each CMR is a 1-port resource. In one example, Z=N. In one example, Z=Nₜᵣₚ. In one example, Z=aN or aNₜᵣₚ where a≥1. Each CMR-i can be associated with (or linked to) a TRP r=1, . . . , N.

In one example, the time domain (TD) granularity of the CMRs (i.e. time density) is s symbols, where s∈{1,2,4}(cf. phase tracking reference signal (PTRS)). In one example, the FD granularity of the CMRs (i.e. frequency density) is t REs/RB, where t∈{1,3}(cf. TRS).

For reporting, the UE determines/reports
In one example, w_{i,r}=(δt_{i,r}, δf_{i,r}) as described herein.
In one example, (amp, phase) aᵣe^{jϕr}˜Aᵣe^{j2π(f+Δf)(t+Δt)} as described herein.

The report can also include additional information as described in one or more schemes herein.

Among the pros of this scheme is that there is the reduction in number of CMRs or CMR overhead (when compared with one or more schemes described herein). Among the cons of this scheme is the increased reporting overhead.

In an alternate design
For measurement:
   Each CMR is a 1 or 2 port resource, which can correspond to (N₁, N₂)=(1,1).
   Each CMR can be a≥4 port resource, which can correspond to (N₁, N₂) with N₁N₂≥2.
In one example, there can be a SD Basis, which can be fixed basis (no reporting), e.g. identity, or orthogonal DFT (with or without oversampling (O₁, O₂); or can be reported.
In one example, for frequency offset (FO), similar to FD, the granularity can be finer than SB, e.g. per PRB or per sub-PRB (comprising <12 subcarriers).
In one example, for time offset (TO), similar to Doppler domain (DD), the granularity can be, e.g. per slot, per x symbols (e.g. x=4 for TRS), 1, 2, 3, 4, 5 slots.

At least one of the examples is used/configured regarding the codebook for reporting.
In one example, the amplitude or/and phase codebooks corresponds to or is similar to or includes at least some of the typical aspects (Rel.15, Rel.16 Type II, or Rel.18 time-domain channel property (TDCP)).
In one example, the codebook is a vector codebook.
In one example, the codebook corresponds to explicit feedback (e.g. based on principal components analysis (PCA) or Eigen basis).

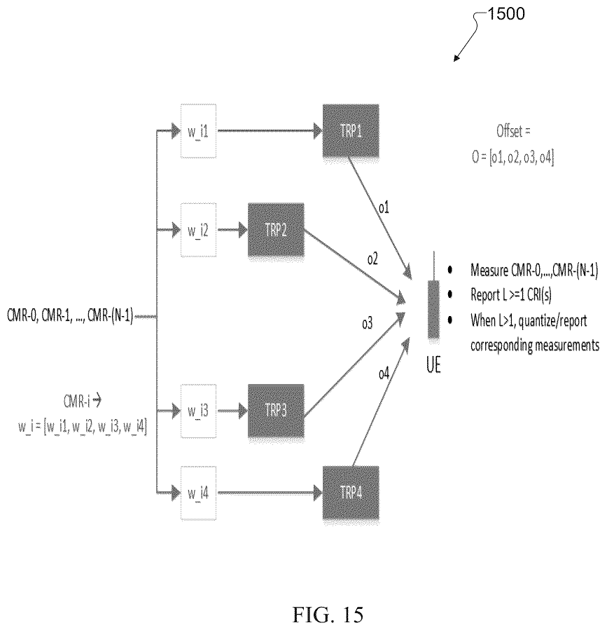

FIG. 15 illustrates a diagram of an example system 1500 for measurement and reporting according to embodiments of the present disclosure. For example, system 1500 for measurement and reporting can be implemented by the UE 115 and the gNB 102 and/or network 130 in the wireless network 100 of FIG. 1. This example is for illustration only and other embodiments can be used without departing from the scope of the present disclosure.

In one embodiment, a UE is configured with a measurement and a report (e.g. CSI report), as described herein, based on Scheme 3 (shown in FIG. 15), which is a combination of one or more schemes described herein.

The details of the CMRs are the same as in one or more schemes described herein.

The report corresponds to a two-level report, where Level 1 (based on one or more schemes described herein) includes L≥1 CRI(s), and Level 2 (based on Scheme 2) when L>1, includes L offsets for L selected/indicated CMRs.

Among the pros of this scheme is that Level 2 provides robustness (residual offset based on measurement), and the scheme balances the CMR vs reporting overhead trade-offs. Among the cons of this scheme is that it is more complex than one or more schemes described herein.

In one embodiment, a UE is configured with a measurement and a report (e.g. CSI report) including calibration-related information (CLI) to enable/facilitate calibration/synchronization across Nₜᵣₚ≥1 TRPs or AGs/PGs or CSI-RS resources based on one or more schemes described herein.
In one example, the UE is configured with one of the three schemes, e.g. via RRC, or MAC CE or DCI.
In one example, the configuration is subject to or based on the UE capability reporting for the support one or more schemes described herein.
In one example, the UE selects one of the 3 schemes, and reports the selection information.

In one embodiment, a UE is configured with a calibration mechanism, wherein the UE is configured with DL measurement RS(s), or DL measurement RS set(s) or DL port(s), or DL PGs to perform one or more DL RS reception(s)/measurement(s). In the rest of the disclosure, DL RS(s) are used which can be anyone of the DL measurement RS(s), or DL measurement RS set(s) or DL port(s), or DL PGs.

In one example, the DL RS(s) (or port(s) or PGs) can be one of or multiple of the following examples.
In one example, DL RS(s) can only be NZP CSI-RS resource(s), which can be at least one of or multiple of the following.
   In one example (CSI-RS for CSI reporting), NZP CSI-RS resource(s) can be configured with {2,4,8,12,16,24,32}CSI-RS ports (and not configured with trs-Info or/and repetition).
   In one example (CSI-RS for tracking (TRS)), NZP CSI-RS resource(s) can be configured with 1 CSI-RS port and configured with trs-Info.
   In one example (CSI-RS for beam reporting), NZP CSI-RS resource(s) can be configured with 1 or 2 CSI-RS ports (and configured with repetition ON or OFF).
   In one example (a new type/usage of CSI-RS), NZP CSI-RS resource(s) can be configured with ‘calibration’ indicating the purpose or usage of these resources. The number of NZP CSI-RS ports can be fixed, e.g. 1. The number of NZP CSI-RS ports can be configured, e.g. from {2,4,8,12,16,24,32}, or {1,2,4,8,12,16,24,32}.
In one example, the DL RS(s) can also be SSB (/PBCH) resources (e.g. IE CSI-SSB-ResourceSet).
In one example, the DL RS(s) can be DL DMRSs (e.g. DMRS for PDCCH or/and DMRS for PDSCH).
In one example, the DL RS(s) can be a dedicated or new DL RS designed for calibration purpose.
In one example, the DL RS(s) can be one of or both of NZP CSI-RS resources and SSB (CSI-SSB-ResourceSet).
In one example, the DL RS(s) can be one of or both of NZP CSI-RS resources and DL DMRS.
In one example, the DL RS(s) can be one of or multiple of NZP CSI-RS resources, SSB (CSI-SSB-ResourceSet), and DL DMRS.

The UE can also be configured with a report including calibration-related information (e.g., for calibration coefficient or time or/and frequency or/and phase offsets for each TRP or relative to a reference TRP), the report being liked to DL RS(s). For example, the UE is configured with a measurement and a report (e.g. CSI or calibration report) including calibration-related information (CLI) to enable/facilitate calibration/synchronization across Nₜᵣₚ≥1 TRPs or AGs/PGs or CSI-RS resources.

In one example, the DL RS(s) can be configured via one or more than one higher layer IE CSI-ResourceConfig (CSI resource settings), each indicating S≥1 sets of NZP CSI-RS resource(s).

In one example, the DL RS(s) can be configured via one or more than one higher layer IE NZP-CSIRS-ResourceSet, each indicating a set of NZP CSI-RS resource(s). In one example, the DL RS(s) can be configured via one or more than one higher layer IE NZP-CSIRS-Resource, indicating a NZP CSI-RS resource. In one example, the DL RS(s) can be configured via one or more than one higher layer IE PDSCH-Config. In one example, the DL RS(s) can be configured via higher layer IE MeasObj (e.g., CSI-RS for mobility).

In one example, the report can be configured via higher layer CSI-ReportConfig with reportType or reportQuantity set to a new value, e.g. ‘calibration’ or ‘cjt-calibration’.

In one example, the calibration report includes at least one indicator indicating (A) delay offset(s) across TRPs (NZP CSI-RS resources), as described in this disclosure. In one example, the calibration report includes at least one indicator indicating (B) frequency/phase offset(s) across TRPs (NZP CSI-RS resources), as described in this disclosure. In one example, the calibration report includes at least one joint indicator or two separate indicators indicating both (A) and (B), as described in this disclosure.

In one example, when TRS resource(s) or resource set(s) is configured for reporting the calibration-related information (CLI), then a UE expects to be configured with a CSI-ReportConfig with the higher layer parameter reportQuantity set to ‘calibration’ or ‘CLI’ (or ‘TDCP’ or ‘none’) for aperiodic NZP CSI-RS resource set configured with trs-Info.

In one example, if TRS resource(s) or resource set(s) can't be configured for reporting the calibration-related information, then a UE does not expect to be configured with a CSI-ReportConfig for periodic NZP CSI-RS resource set configured with trs-Info and reportQuantity set to ‘calibration’ or ‘CLI’.

An example of a CSI-ResourceConfig IE is shown in Table 1, which defines or includes
A list of one or more the following types of lists of resources:
   TypeA-1: A list of one of more NZP-CSI-RS-ResourceSet, or
   TypeA-2: A list of one of more CSI-IM-ResourceSet, or
   TypeA-3: A list of one of more CS-SSB-ResourceSet.
BWP-Id: indicating the location of the CSI-ResourceConfig in the DL BWP,
resourceType: indicating the time domain behavior, i.e. aperiodic (AP), semiPersistent (SP), or periodic (P).

TABLE 1

```
An example of CSI-ResourceConfig information element
CSI-ResourceConfig ::= SEQUENCE {
  csi-ResourceConfigId CSI-ResourceConfigId,
  csi-RS-ResourceSetList CHOICE {
    nzp-CSI-RS-SSB SEQUENCE {
      nzp-CSI-RS-ResourceSetList SEQUENCE (SIZE (1..maxNrofNZP-CSI-RS-
ResourceSetsPerConfig)) OF NZP-CSI-RS-ResourceSetId
                                                              OPTIONAL, -- Need
R
      csi-SSB-ResourceSetList  SEQUENCE (SIZE (1..maxNrofCSI-SSB-
ResourceSetsPerConfig)) OF CSI-SSB-ResourceSetId OPTIONAL -- Need R
    },
  csi-IM-ResourceSetList SEQUENCE (SIZE (1..maxNrofCSI-IM-
ResourceSetsPerConfig)) OF CSI-IM-ResourceSetId
  },
  bwp-Id BWP-Id,
  resourceType ENUMERATED { aperiodic, semiPersistent, periodic },
  ...,
}
```

In one example, for calibration reporting, a UE can only be configured with X=1 CSI Resource Setting CSI-ResourceConfig (hence does not expect or is not expected to X>1).

In one example, when X=1, and S>1, resources sets are of the same type.
In one example, only TypeA-1.
In one example, only one of TypeA-1 or TypeA-3.

In one example, when X=1 and S>1, resources sets can be of the same type of different types.
In one example, when the same, only TypeA-1.
In one example, when different, any of TypeA-1 or TypeA-3.
In one example, when different, a combination of TypeA-1 or TypeA-3.

In one example, for calibration reporting, a UE can be configured with X≥1 CSI Resource Settings CSI-ResourceConfig.

In one example, when X>1, resources settings are of the same type (e.g. TRP resource setting, CSI resource setting etc.).
In one example, resources settings with resource sets of TypeA-1.
In one example, resources settings with resource sets of TypeA-1 or TypeA-3.

In one example, when X>1, resources settings can be of the same type of different types (e.g. TRP resource setting, CSI resource setting etc.).
In one example, when the same, resources settings with resource sets of TypeA-1.
In one example, when different, resources settings with resource sets of of TypeA-1 or TypeA.3.
In one example, when different, resources settings with resource sets of any combination of TypeA-1 or TypeA-3.

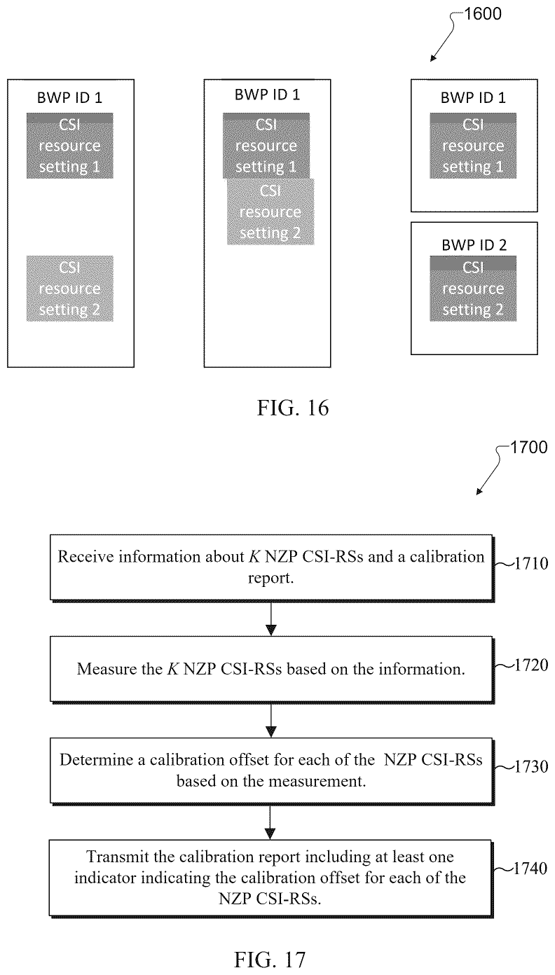

FIG. 16 illustrates a diagram of example DL BWP resources 1600 according to embodiments of the present disclosure. For example, any of the UEs 111-116 of FIG. 1 can be configured with DL BWP resources 1600. This example is for illustration only and other embodiments can be used without departing from the scope of the present disclosure.

In one example, when X>1,
In one example, for calibration reporting, each CSI Resource Setting is located in the DL BWP identified by the higher layer parameter BWP-id, and CSI Resource Settings linked to a CSI Report Setting (for calibration reporting) have the same DL BWP. This implies there is only one BWP-id.
In one example, for calibration reporting, each CSI Resource Setting is located in the DL BWP identified by the higher layer parameter BWP-id, and CSI Resource Settings linked to a CSI Report Setting (for calibration reporting) can have the same DL BWP or different DL BWPs. When different, this implies there is more than one BWP-ids, for example BWP-id corresponds to a sequence of (BWP ID1, BWP ID2, . . . ). In one example, the sequence includes X number of BWP IDs.

With reference to FIG. 16, a few examples are shown for X=2.

In one example, when X>1,
In one example, for calibration reporting, CSI Resource Settings linked to a CSI Report Setting (for calibration reporting) have the same resourceType. This implies there is only one resourceType.
In one example, for calibration reporting, CSI Resource Settings linked to a CSI Report Setting (for calibration reporting) can have the same resourceType or different resourceType. When different, this implies there is more than one resourceType, for example resourceType corresponds to a sequence of (resourceType 1, resourceType 2, . . . ). In one example, the sequence includes X number of resourceType.

In one example, when CSI Resource Settings linked to a CSI Report Setting (for a calibration reporting) shall have the same time domain behavior,
In one example, only aperiodic (AP).
In one example, one of AP and semi-persistent (SP) (i.e., not P).
In one example, one of {P, SP, or AP}

In one example, CSI Resource Settings linked to a CSI Report Setting (for a calibration reporting) shall have the same or different time domain behavior from {P, SP, or AP}. When different
In one example, only AP and SP.
In one example, only AP and P.
In one example, only SP and P.
In one example, any two of {P, SP, AP}.
In one example, any of {P, SP, AP}.

In one example, the time domain behavior of the CSI-RS resources within a CSI Resource Setting are indicated by the higher layer parameter resourceType and can be set to
In one example, only aperiodic (AP).
In one example, only AP, or semi-persistent (SP).
In one example, only one of aperiodic, periodic, or semi-persistent.
In one example, a combination of AP and SP.
In one example, a combination of AP and P.
In one example, a combination of P and SP.
In one example, a combination of AP, P and SP.

In one example, for calibration reporting, a UE can be configured with (X=1) a P/SP CSI resource settings with S CSI resource sets.
In one example, S=fixed (1 or 2) when calibration.
In one example, S=configured from {1,2}.
In one example, S=K_{cal} (same as for TDCP report), where K_{cal}∈S, for example, S={1,2,3}.

An example of a NZP-CSI-RS-ResourceSet IE is shown in Table 2, which defines or includes
A list/sequence of T≥1 NZP CSI-RS resources, via IE nzp-CSI-RS-Resource
Repetition: when on, the NZP CSI-RS resource(s) will be transmitted repeatedly in a number of time slots/symbols.
aperiodicTriggeringOffset: indicates an offset between the slot carrying the DCI that triggers a aperiodic resource set, and the slot in which NZP CSI-RS resource(s) is measured.
trs-Info: when true, this set is a TRS resource set (as described in this disclosure).
cmrGroupingAndPairing-r17: indicates that the resource set partitioned into multiple groups (e.g. 2) of NZP CSI-RS resources, and can also include one or more pairs of NZP CSI-RS resources, one from each of the multiple groups.

TABLE 2

```
NZP-CSI-RS-Resource Set information element
NZP-CSI-RS-ResourceSet ::= SEQUENCE {
  nzp-CSI-ResourceSetId NZP-CSI-RS-ResourceSetId,
  nzp-CSI-RS-Resources SEQUENCE (SIZE (1..maxNrofNZP-CSI-RS-
ResourcesPerSet)) OF NZP-CSI-RS-ResourceId,
  repetition ENUMERATED { on, off }
OPTIONAL, -- Need S
  aperiodicTriggeringOffset INTEGER(0..6)
OPTIONAL, -- Need S
  trs-Info ENUMERATED {true}
OPTIONAL, -- Need R
  ...,
  cmrGroupingAndPairing-r17 CMRGroupingAndPairing-r17
}
CMRGroupingAndPairing-r17 ::= SEQUENCE {
  nrofResourcesGroup1-r17 INTEGER (1..7),
  pair 1OfNZP-CSI-RS-r17 NZP-CSI-RS-Pairing-r17
OPTIONAL, -- Need R
  pair2OfNZP-CSI-RS-r17 NZP-CSI-RS-Pairing-r17
OPTIONAL -- Need R
}
NZP-CSI-RS-Pairing-r17 := SEQUENCE {
  nzp-CSI-RS-ResourceId1-r17 INTEGER (1..7),
  nzp-CSI-RS-ResourceId2-r17 INTEGER (1..7)
}
```

An example of a CSI-SB-ResourceSet IE is shown in Table 3, which defines or includes
A list/sequence of T≥1 SSB indices, via IE SSB-Index
ServingAdditionalPCIIndex-r17:
   If not provided: there is only one PCI value associated with T SSB indices.
   If provided, there are multiple PCI values,
      the PCI value of the serving cell,
      Additional PCI values different from the PCI value of the serving cell (e.g. PCI values associated with non-serving cells).

TABLE 3

```
CSI-SSB-ResourceSet information element
CSI-SSB-ResourceSet ::= SEQUENCE
  csi-SSB-ResourceSetId CSI-SSB-ResourceSetId,
  csi-SSB-ResourceList SEQUENCE (SIZE(1..maxNrofCSI-SSB-ResourcePerSet)) OF
SSB-Index,
  ...,
  [[
  servingAdditionalPCIList-r17 SEQUENCE (SIZE(1..maxNrofCSI-SSB-ResourcePerSet)
OF ServingAdditionalPCIIndex-r17 OPTIONAL -- Need R
  ]]
}
ServingAdditionalPCIIndex-r17 ::= INTEGER(0..maxNrofAdditionalPCI-r17)
```

In one example, for calibration reporting, a UE (e.g., the UE 116) can only be configured with Y=1 resource set, either NZP CSI Resource set or CSI-SSB resource set (hence does not expect or is not expected to Y>1).

In one example, when Y=1, and T>1, NZP CSI-RS resources or SSB resources are of the same type.
In one example, (Type B-1) same parameter value for Repetition.
In one example, (Type B-2) same parameter value for aperiodicTriggeringOffset.
In one example, (Type B-3) same parameter value for trs-Info.
In one example, (Type B-4) same parameter value for cmrGroupingAndPairing-r17.
In one example, (Type B-5) Type B-1 or/and Type B-2.
In one example, (Type B-6) Type B-1 or/and Type B-3.
In one example, (Type B-7) Type B-1 or/and Type B-4.
In one example, (Type B-8) Type B-2 or/and Type B-3.
In one example, (Type B-9) Type B-2 or/and Type B-4.
In one example, (Type B-10) Type B-3 or/and Type B-4.
In one example, (Type B-11) Type B-1 or/and Type B-2 or/and Type B-3.
In one example, (Type B-12) Type B-1 or/and Type B-2 or/and Type B-4.
In one example, (Type B-13) Type B-1 or/and Type B-3 or/and Type B-4.
In one example, (Type B-14) Type B-2 or/and Type B-3 or/and Type B-4.
In one example, (Type B-15) Type B-1 or/and Type B-2 or/and Type B-3 or/and Type B-4.

In one example, when Y=1, and T>1, SSB resources are of the same type.
In one example, (Type B-16) same parameter value for ServingAdditionalPCIndex-r17.

In one example, when Y=1 and T>1, NZP CSI-RS resources or SSB resources can be of the same type or different types. When different,
In one example, different parameter value for only one parameter (Type B-1 through B-4).
In one example, different parameter values for at most two parameters (Type B-1 through B-10).
In one example, different parameter values for at most three parameters (Type B-1 through B-14).
In one example, different parameter values for any parameters (Type B-1 through B-15).

In one example, for calibration reporting, a UE can only be configured with Y≥1 resource set, either NZP CSI Resource set or CSI-SSB resource set.

In one example, when Y>1, resources sets are of the same type (e.g. NZP CSI-RS resource set, CSI-SSB-ResourceSet).
In one example, resources sets with resources of one type (e.g. TypeB-1 through B-16).
In one example, resources sets with resources of at most two types (from TypeB-1 through B-16).
In one example, resources sets with resources of one type, e.g. NZP CSI-RS resource set or CSI-SSB-ResourceSet.

In one example, when Y>1, resources sets can be of the same type or different types (e.g. NZP CSI-RS resource set, CSI-SSB-ResourceSet).
In one example, when the same, resources sets with resources of one type (e.g. TypeB-1 through B-16).
In one example, when the same, resources sets of at most two types (from TypeB-1 through B-16).
In one example, when the same, resources sets with resources (e.g. TypeB-1 through B-16).
In one example, when different, resources sets with any combination of NZP CSI-RS resource set or CSI-SSB-ResourceSet.
In one example, when different, resources sets with resources which are any combination of NZP CSI-RS resources or SSB resources.
In one example, when different, resources sets with resources of any combination (e.g. TypeB-1 through B-16).

In one example, when Y>1,
In one example, for calibration reporting, CSI Resource sets linked to a CSI Report Setting (for calibration reporting) have the same value for parameter, P. This implies there is only one P.
In one example, for calibration reporting, CSI Resource sets linked to a CSI Report Setting (for calibration reporting) can have the same or different value for parameter, P. When different, this implies that the parameter, P corresponds to a sequence of (P1, P2, . . . ). In one example, the sequence includes Y number of values (or IDs).
In one example, for calibration reporting, CSI Resource sets linked to a CSI Report Setting (for calibration reporting) have the same value for parameter, P and parameter Q where P #Q (two different parameters). This implies there is only one value for each of P and Q.
In one example, for calibration reporting, CSI Resource sets linked to a CSI Report Setting (for calibration reporting) can have the same or different value for parameter; P and parameter Q where P≠Q (two differentparameters). When different, this implies that the parameter, P corresponds to a sequence of (P1, P2, . . . ), and likewise this implies that the parameter, Q corresponds to a sequence of (Q1, Q2, . . . ). In one example, the sequence includes Y number of values (or IDs).
In one example, for calibration reporting, CSI Resource sets linked to a CSI Report Setting (for calibration reporting) have the same value for parameter, P and can be a different value for parameter Q where P≠Q (two differentparameters). This implies there is only one value for each of P but Q corresponds to a sequence of (Q1, Q2, . . . ). In one example, the sequence includes Y number of values (or IDs).

In one example, the parameter P or Q belong to {Repetition, aperiodicTriggeringOffset}. In one example, the parameter P or Q belong to {Repetition, aperiodicTriggeringOffset, trs-Info}. In one example, the parameter P or Q belong to {Repetition, trs-Info}. In one example, the parameter P or Q belong to {Repetition, aperiodicTriggeringOffset, trs-Info, cmrGroupingAndPairing-r17}.

In one example, when CSI Resource Sets linked to a CSI Report Setting (for a calibration reporting) shall have the same time domain behavior,
In one example, only aperiodic (AP).
In one example, one of AP and semi-persistent (SP) (i.e., not P).
In one example, one of {P, SP, or AP}

In one example, CSI Resource Sets linked to a CSI Report Setting (for a calibration reporting) shall have the same or different time domain behavior from {P, SP, or AP}. When different
In one example, only AP and SP.
In one example, only AP and P.
In one example, only SP and P.
In one example, any two of {P, SP, AP}.
In one example, any of {P, SP, AP}.

In one example, the time domain behavior of the NZP CSI-RS resources within a CSI Resource Sets are indicated by the higher layer parameter resourceType1 and can be set to
In one example, only aperiodic (AP).
In one example, only AP, or semi-persistent (SP).
In one example, only one of aperiodic, periodic, or semi-persistent.
In one example, a combination of AP and SP.
In one example, a combination of AP and P.
In one example, a combination of P and SP.
In one example, a combination of AP, P and SP.

In one example, the NZP-CSI-RS resources associated with a NZP-CSI-RS resource set.
In one example, the number of NZP CSI RS resources per NZP CSI resource set is fixed (e.g. 1, 2, 3, 4 or 8 or 12). This number can subject to UE capability reporting.
In one example, the maximum number of NZP CSI RS resources per NZP CSI resource set is fixed (e.g. 8 or 12). This maximum number can subject to UE capability reporting.

In one example, the NZP-CSI-RS resources associated with Y>1 NZP-CSI-RS resource sets.
In one example, the number of NZP CSI RS resources per NZP CSI resource set is fixed (e.g. 1, 2, 3, 4 or 8 or 12). This number can subject to UE capability reporting.
In one example, the maximum number of NZP CSI RS resources per NZP CSI resource set is fixed (e.g. 8 or 12). This maximum number can subject to UE capability reporting.
In one example, the total number of NZP CSI RS resources across NZP CSI resource sets is fixed (e.g. 1, 2, 3, 4 or 8 or 12). This total number can subject to UE capability reporting.
In one example, the maximum total number of NZP CSI RS resources across NZP CSI resource set is fixed (e.g. 8 or 12). This maximum total number can subject to UE capability reporting.

In one example, for periodic CSI Resource Settings, when the UE is configured with calibration reporting, for which the number of CSI-RS Resource Sets in the CSI Resource Setting for channel measurement is S=K_{cal} and the CSI-RS Resource Sets are configured with the higher layer parameter trs-Info.

In one example, for calibration reporting, for P/SP CSI resource settings, the configured periodicity and slot offset is given in the numerology of its associated DL BWP, as given by BWP-id.
In one example, CSI Resource Settings linked to a CSI Report Setting (for calibration reporting) have the same DL BWP. This implies there is only one BWP-id.
In one example, CSI Resource Settings linked to a CSI Report Setting (for calibration reporting) can have the same DL BWP or different DL BWPs. When different, this implies there is more than one BWP-ids, for example BWP-id corresponds to a sequence of (BWP ID1, BWP ID2, . . . ). In one example, the sequence includes X number of BWP IDs.

In one example, for calibration reporting, the UE may expect that the NZP CSI-RS resource(s) for channel measurement [or/and, if configured, the CSI-IM resource(s) for interference measurement] configured for one CSI reporting are resource-wise QCLed with respect to ‘typeD’.

In one example, for calibration reporting, the UE is configured with X=1 CSI resource setting for channel measurement.
In one example, the UE may expect that same 1 port NZP CSI-RS resource(s) with density 3 REs/RB is used.
In one example, the UE may expect that same N port NZP CSI-RS resource(s) with density 3 REs/RB is used, where N∈{1,2}.
In one example, the UE may expect that same N port NZP CSI-RS resource(s) with density 3 REs/RB is used, where N∈{2,4}.
In one example, the UE may expect that same N port NZP CSI-RS resource(s) with density 3 REs/RB is used, where N∈{2,4,12} or {2,4,8,12}.
In one example, the UE may expect that same N port NZP CSI-RS resource(s) with density 3 REs/RB is used, where N∈{1,2,4,8,12,16,32}.

In one example, for calibration reporting, the UE is configured with X=1 CSI resource setting for both channel and interference measurement.
In one example, the UE may expect that same 1 port NZP CSI-RS resource(s) with density 3 REs/RB is used for both channel and interference measurements.
In one example, the UE may expect that same N port NZP CSI-RS resource(s) with density 3 REs/RB is used, where N∈{1,2}.
In one example, the UE may expect that same N port NZP CSI-RS resource(s) with density 3 REs/RB is used, where N∈{2,4}.
In one example, the UE may expect that same N port NZP CSI-RS resource(s) with density 3 REs/RB is used, where N∈{2,4,12} or {2,4,8,12}.
In one example, the UE may expect that same N port NZP CSI-RS resource(s) with density 3 REs/RB is used, where N∈{1,2,4,8,12,16,32}.

In one example, for calibration reporting, the UE is configured with X=2 resource settings for channel measurement (e.g. each corresponding to a TRP).

In one example, for calibration reporting, the UE is configured with K_{cal} resource settings for channel measurement (e.g. each corresponding to a TRP).

In one example, for calibration reporting, the UE is configured with X=2 resource settings, one for channel measurement and one for interference measurement. In one example, there is a one-to-one mapping b/w CMR and IMR.

In one example, for calibration reporting, the UE is configured with a CSI Resource Setting which comprises of
a list of Z≥1 synchronization signal/physical broadcast channel (SS/PBCH) blocks indices (given by [cal-csi-SSB-ResourceList]) and
a list of Z [PCI indices](given by [cal-CandidateId-list]) referring to cells associated with the SS/PBCH block indices.

The UE determines the time domain behavior of a SS/PBCH block from ssb-Periodicity and ssb-PositionsInBurst and the frequency domain behavior of a SS/PBCH block is determined by the higher layer parameters subcarrierspacing, ssbFrequency.

In one example, for AP calibration reporting, the number of CSI resource settings.
X=1: one for channel measurement (CMR) or (CMR and IMR)
X=1: one for channel measurement and interference measurement (IMR)
X=2: one for CMR, and one for IMR
X=3: one for CMR, one for IMR (CSI-IM), one for IMR (NZP CSI-RS)

In one example, for AP calibration reporting, the number of CSI resource sets
In one example, for P/SP resource settings,
   S=1 set
   S=2 sets
   S=K_{cal}
In one example, for AP resource setting, S=K_{cal}.

In one example, for calibration reporting, a UE configured with a CSI-ReportConfig with the higher layer parameter reportQuantity set to ‘calibration’ or ‘time-frequency-offset’ is expected to be configured with one CSI Resource Setting (given by higher layer parameter resourcesForChannelMeasurement) in CSI-ReportConfig.

In one example, the CSI Resource Setting may be configured without higher layer parameter trs-Info (i.e., CSI-RS resources correspond to CSI-RS for CSI reporting with N_{CSIRS}∈{1,2,4,8,12,16,24,32} ports per CSI-RS resource. The resources can be P/SP/AP resources.
In one example, there may be a restriction on a max value of N_{CSIRS}, e.g. N_{CSIRS}≤x where x can be fixed (e.g. 8) or reported by the UE as part of UE capability reporting, or it may depend on number of CSI-RS resources in the resource set.
In one example, there may be a restriction on a max value of a total of N_{CSIRS} across CSI-RS resources in the resource set.

In one example, the CSI Resource Setting may be configured with trs-Info
In one example, may be periodic, with K_{cal}∈{1, 2, 3}CSI-RS Resource Sets configured with higher layer parameter trs-Info.
The support of K_{cal}=2 or 3 is subject to UE capability indication.

In one example, the CSI Resource Setting may be configured with trs-Info
In one example, may be periodic, with K_{cal}∈{1, 2, 3}CSI-RS Resource Sets configured with higher layer parameter trs-Info or aperiodic, with a single CSI-RS Resource Set configured with higher layer parameter trs-Info.
The support of K_{cal}=2 or 3 is subject to UE capability indication.

The UE can expect that the CSI-RS resources in the Kcal CSI-RS Resource Sets share the same QCL-TypeA/C and, if applicable, TypeD.

In one example, for calibration reporting, the CSI-RS measurement in frequency domain are as follows.
In one example, the CSI-RS resources in the CSI-RS Resource Set(s) are configured with the same bandwidth and subcarrier locations.
In one example, the CSI-RS resources in the CSI-RS Resource Set(s) are configured with the same bandwidth but subcarrier locations can be same or different.
   In one example, whether the same or different is based on (RRC) configuration, or triggered via MAC CE or DCI.
   In one example, the CSI-RS resources in the CSI-RS Resource Set(s) are configured with the same density (d) (e.g. 1 or 3) but there is an offset (o) between the CSI-RS resources in frequency domain. For example, the offset corresponds to a separation (e.g. in number of REs) in frequency domain. The offset can be fixed (e.g. o=3, 6), or configured (RRC or DCI), or can depend on the density. For example, d=1 and o=4).
In one example, the CSI-RS resources in the CSI-RS Resource Set(s) are configured with the same or different (overlapping, partially overlapping) bandwidth.
   In one example, completely overlapping.
   In one example, partially overlapping (at least one PRB or 4PRBs or SB).

In one example, for calibration reporting, a UE configured with a CSI-ReportConfig with the higher layer parameter reportQuantity set to ‘calibration’ is not expected to be configured with interference measurement on CSI-IM and/or NZP-CSI-RS. In one example, for calibration reporting, a UE configured with a CSI-ReportConfig with the higher layer parameter reportQuantity set to ‘calibration’ can be expected to be configured with interference measurement on CSI-IM and/or NZP-CSI-RS.

In one example, for calibration reporting, there are at least one of the following restrictions.
In one example, a UE is not expected to be configured with
   more than one CSI-RS resource in resource set for channel measurement.
In one example, a UE is not expected to be configured with
   more than 64 NZP CSI-RS resources and/or SS/PBCH block resources in resource setting for channel measurement.
In one example, if interference measurement is performed on CSI-IM,
   each CSI-RS resource for channel measurement is resource-wise associated with a CSI-IM resource by the ordering of the CSI-RS resource and CSI-IM resource in the corresponding resource sets.
   The number of CSI-RS resources for channel measurement equals to the number of CSI-IM resources.
In one example, a UE configured with a CSI-ReportConfig with the higher layer parameter reportQuantity set to ‘calibration’ is expected to be configured with
   1≤K≤4 CSI-RS resources in a resource set for channel measurement or
   K∈{4,8,12} aperiodic CSI-RS resources in a resource set for channel measurement.
In one example, for an aperiodic CSI-RS resource set for channel measurement, the K CSI-RS resources are triggered by the same triggering instance and the separation between two consecutive CSI-RS resources is either fixed, e.g. m=1 slot or configured, e.g. m E {1,2} slots via RRC, or provided via MAC CE or DCI.
In one example, in frequency domain,
   In one example, the separate between the same port index of consecutive CSI-RS resources can be the same.
   In one example, the separate between the same port index of consecutive CSI-RS resources can be the fixed (subcarrier separation).
In one example, for calibration reporting, the UE shall expect that the antenna port with the same port index of the K aperiodic CSI-RS resources is the same.
In one example, for calibration reporting, the UE shall expect that the antenna port with the same port index of the K aperiodic CSI-RS resources ca be same or different.
In one example, for calibration reporting, a UE configured with a CSI-ReportConfig with the higher layer parameter reportQuantity set to ‘calibration’ is not expected to be configured with interference measurement on CSI-IM and/or NZP-CSI-RS.
In one example, for calibration reporting, a UE can be configured with interference measurement on CSI-IM and/or NZP-CSI-RS, but only 1 resource can be configured.

In one example, for calibration reporting, an NZP CSI-RS Resource Set for channel measurement with 2≤Kₛ≤8 resources can be configured with two Resource Groups, with K₁≥1 resources in Group 1 and K₂≥1 resources in Group 2. In one example, K₁+K₂=Kₛ.

In one example, for calibration reporting, an NZP CSI-RS Resource Set for channel measurement with 2≤Kₛ≤8 resources can be configured with g>2 Resource Groups with Kᵢ≥1 resources in Group i=1,2,3.

In one example, for calibration reporting, an NZP CSI-RS Resource Set for channel measurement includes N∈{1,2} Resource Pairs.
Each Resource Pair includes of one resource from Group 1 and one resource from Group 2.
The same resource can be associated with two Resource Pairs in frequency range 1 but not in frequency range 2.

In one example, for a CSI-ReportConfig configured with the higher layer parameter reportQuantity set to ‘calibration’, after the CSI report (re)configuration, serving cell activation, BWP change, the UE reports a CSI report only after receiving at least one CSI-RS transmission occasion for each CSI-RS resource in the K_{cal} CSI-RS Resource Sets of the CSI-RS Resource Setting for channel measurement no later than the CSI reference resource.

In one example, an aperiodic CSI report carried on the PUSCH supports wideband, e.g. calibration reporting.

In one example, when the higher layer parameter reportQuantity is configured with, ‘calibration’, the CSI feedback includes a single part.

In one example, a CSI Reporting Setting is said to have a wideband frequency-granularity if reportQuantity is set to ‘calibration’ or ‘calibration reporting’.

In one example, calibration reporting is via a one-part UCI (e.g. PUCCH).

In one example, calibration reporting is via part 1 of two-part UCI (on PUCCH or PUSCH).

In one example, calibration reporting is via part 2 of two-part UCI (on PUCCH or PUSCH).

In one example, calibration reporting is via only one of part 1 or part 2 of two-part UCI (on PUCCH or PUSCH).

In one example, calibration reporting is via part 1 and part 2 of two-part UCI (on PUCCH or PUSCH), similar to two-part CSI reporting.

In one example, (based on while calibration reporting) a UE can be configured with K>N_{TRP} AP NZP CSI-RS resources.
In one example, MAC CE to activate N_{TRP} out of K.
In one example, DCI to indicate N_{TRP} out of K.
In one example, MAC CE to activate N out of K and DCI to indicate N_{TRP} out of N.

In one example, K=xN_{TRP} where x is a number of sets or subsets or sub-configurations whose IDs are indicated via RRC (e.g. CSI-ReportConfig).

In one example, K=Σᵢ₌₁^{x}N_{TRP,i} where x is a number of sets or subsets or sub-configurations and N_{TRP,i}∈{1,2,3,4}.
In one example, MAC CE to activate 1 out of x.
In one example, DCI to indicate 1 out of x.
In one example, MAC CE to activate N out of x and DCI to indicate 1 out of N.

Here, x can correspond to number of different delay or/and frequency offset alignment/calibration/synchronization.

If the UE (e.g., the UE 116) is configured with a CSI-ReportConfig with the higher layer parameter reportQuantity set to ‘calibration’, the value of Y E S is configured by higher layer parameter Y, such that the UE is expected to report the Y or Y−1 (assuming 1 reference, as described) delay offset values. Values of Y>1 can be configured subject to UE capability. In one example, S={1, 2, . . . , V}. The value V can be fixed (e.g. 4 or 6 or 8). In one example, S={1, . . . , V} and V is up to UE capability. For example, a max value of Y is reported by the UE, e.g., from {4, 6, 8}.

In one example, the value can be fixed to Y=N_{cal} (number of NZP CSI-RS resources).

In one example, the value of Y≤N_{cal}.
In one example, UE reports the value of Y.
In one example, UE is configured with the value of Y.

In one example, the UE can be configured with a set of candidate delay offset values (e.g. from a codebook) or frequency offset values or phase offset values (from respective) codebooks, e.g. similar to codebook subset restriction (CBSR) indicating each or a subset of the values from the codebook for calibration reporting.

Let hᵣ be the measurement associated with r-th TRP (or CSI-RS resource or DL RS), where r=1, . . . , N and

$$H = [ \begin{matrix}{h}_{1} ( t - δ {t}_{1} , f - δ {f}_{1} ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ]$$

be the composite/aggregated channel at a T-F unit (t,f) and {(δtᵣ, δfᵣ)} be the offsets associated with TRPs.

As described in this disclosure, one of the N TRPs can be a reference, whose offset can be fixed, e.g. to zero. Without loss generality, the reference TRP (resource) corresponds to (the 1^{st} TRP) r*=1 for which (δt₁, δf₁)=(0,0), i.e.,

$$H = [ \begin{matrix}{h}_{1} ( t , f ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ] .$$

In one example, values of (δtᵣ, δfᵣ), based on the measurement, can be provided/used to determine the report.

In one example, a low-pass or a window-based approach can be used for the report. In one example, the window corresponds to value of (δtᵣ, δfᵣ) that are around the reference. For instance, δtᵣ≤Wₜ and/or δfᵣ≤W_{f}, where (Wₜ, W_{f}) corresponds to the window length or max value of (δtᵣ, δfᵣ) that can be provided/used for the report, (Wₜ, W_{f}) can be fixed, or configured, or reported by the UE.

In one example, the measurement and reporting for T-F offset is decoupled/separate, i.e., one of the two separate mechanisms can be configured/used.
For time offset (δtᵣ), the measurement corresponds to multiple (a burst of) time occasions, where two consecutive time occasions can be separated by d symbols or slots.
For frequency offset (δfᵣ), the measurement corresponds to multiple (a burst of) frequency occasions, where two consecutive frequency occasions can be separated by d subcarriers or PRBs or SBs.

In one example, the measurement and reporting for T-F offset is coupled/joint, i.e., one joint mechanism is used/configured for a 2D measurement and reporting for (δtᵣ, δfᵣ).

At least one of the following examples is used/configured regarding the frequency domain granularity of the reporting/calculation of offset value(s).
In one example, the reporting/calculation of offset value(s) is in a wideband (WB) manner, i.e., offset values are reported common for the entire CSI reporting band.
In one example, the reporting/calculation of offset value(s) is in a subband (SB) manner, i.e., offset values are reported for each SB in the CSI reporting band. In addition, a reference (WB) offset can also be reported such that Sub-band offset level (s)=sub-band offset index (s)−wideband offset index.

Likewise, at least one of the following examples is used/configured regarding the time domain granularity of the reporting/calculation of offset value(s).
In one example, the reporting/calculation of offset value(s) is in a wide-time (WT) manner, i.e., offset values are reported common for the entire time window or duration (in which the report is expected to be valid).
In one example, the reporting/calculation of offset value(s) is in a sub-time (ST) manner, i.e., offset values are reported for each ST in the time duration (in which the report is expected to be valid). In addition, a reference (WT) offset can also be reported such that ST offset level (s)=ST offset index (s)−WT offset index.

In one example, the report further includes a recommendation about measurement across TRPs. In one example, it can be implicit via one value, or explicit via an indicator (e.g. 1-bit), or via an Nₜᵣₚ-bit or N-bit bitmap indicator, where ‘0’ indicates ‘no measurement’ and ‘1’ indicates measurement. (via NW-triggerred DCI, MAC CE) or UE-initiated (triggered).

TABLE 4

| | | Reporting | |
|---|---|---|---|
| Measurement | | Offset | Corresponding |
| Time | Frequency | value | phase |
| t = t₀ | f ∈ S_{f} = | f (Δt) = | Tₜ = e^{jϕ}^{ₜ} |
| | {f₀, f₁, . . . f_{N}_{_{sc}}₋₁_{}} | e^{j2πf (t}^{₀}^{+Δt)} | |
| t ∈ Sₜ = | f = f₀ | T_{f}_{₀} = | T_{f} = e^{jϕ}^{_{f}} |
| {t₀, t₁, . . . t_{N}_{ₛₗₒₜ}₋₁_{}} | | e^{j2π(f}^{₀}^{+Δf)t} | |
| t ∈ Sₜ | f ∈ S_{f} | Tₜ_{₀}_{, f}_{₀} = | T_{t, f} = e^{jϕ}^{_{t, f}} |
| | | e^{j2π(f+Δf)(t+Δt)} | |

Nₛₗₒₜ=number of time slots for measurement; Nₛₗₒₜ=number of time slots for measurement; N_{sc}=number of subcarriers for measurement (in one slot); a=inter-slot spacing (sec), e.g. 1 msec; and b=subcarrier spacing (Hz), e.g., 15 kHz.

$${h}_{{k}_{1}} = {a}_{{k}_{1}} {e}^{j 2 π {f}_{{k}_{1}} ( {t}_{0} + Δ t )} ∼ {a}_{{k}_{1}} {e}^{j {ϕ}_{{k}_{1}}}$$

$${h}_{{k}_{2}} = {a}_{{k}_{2}} {e}^{j 2 π {f}_{{k}_{2}} ( {t}_{0} + Δ t )} ∼ {a}_{{k}_{2}} {e}^{j {ϕ}_{{k}_{2}}}$$

$$\frac{{h}_{{k}_{2}}}{{h}_{{k}_{1}}} = \frac{{a}_{{k}_{2}}}{{a}_{{k}_{1}}} {e}^{j 2 π ( {f}_{{k}_{2}} - {f}_{{k}_{1}} ) ( {t}_{0} + Δ t )} = \frac{{a}_{{k}_{2}}}{{a}_{{k}_{1}}} {e}^{j 2 π ( {k}_{2} - {k}_{1} ) b ( {t}_{0} + Δ t )}$$

FD phase offset: Δϕₖ=ϕₖ_{₂}−ϕₖ_{₁}=2π(k₂−k₁)b(t₀+Δt)

$${t}_{0} + Δ t = \frac{Δ {ϕ}_{k}}{2 π ( {k}_{2} - {k}_{1} ) b}$$

Assuming t₀=0, delay offset

$$Δ t = \frac{Δ {ϕ}_{k}}{2 π ( {k}_{2} - {k}_{1} ) b}$$

Similarly, TD phase offset: Δϕₗ=ϕₗ_{₂}−ϕₗ_{₁}=2π(l₂−l₁)a(f₀+Δf)

$${h}_{{l}_{1}} = {a}_{{l}_{1}} {e}^{j 2 π ( {f}_{0} + Δ f ) {t}_{{l}_{1}}} ∼ {a}_{{l}_{1}} {e}^{j {ϕ}_{{l}_{1}}}$$

$${h}_{{l}_{2}} = {a}_{{l}_{2}} {e}^{j 2 π ( {f}_{0} + Δ f ) {t}_{{l}_{2}}} ∼ {a}_{{l}_{2}} {e}^{j {ϕ}_{{l}_{2}}}$$

Assuming f₀=0, frequency offset

$$Δ f = \frac{Δ {ϕ}_{l}}{2 π ( {l}_{2} - {l}_{1} ) a}$$

In both TD-FD:

$${h}_{{l}_{1} , {k}_{1}} = {a}_{{l}_{1} , {k}_{1}} {e}^{j 2 π ( {f}_{{k}_{1}} + Δ f ) ( {t}_{{l}_{1}} + Δ t )} ∼ {a}_{{l}_{1} , {k}_{1}} {e}^{j {ϕ}_{{l}_{1} , {k}_{1}}}$$

$${h}_{{l}_{1} , {k}_{2}} = {a}_{{l}_{1} , {k}_{2}} {e}^{j 2 π ( {f}_{{k}_{2}} + Δ f ) ( {t}_{{l}_{1}} + Δ t )} ∼ {a}_{{l}_{1} , {k}_{2}} {e}^{j {ϕ}_{{l}_{1} , {k}_{2}}}$$

$$\frac{{a}_{{l}_{1} , {k}_{2}}}{{a}_{{l}_{1} , {k}_{1}}} {e}^{j 2 π ( {f}_{{k}_{2}} - {f}_{{k}_{1}} ) ( {t}_{{l}_{1}} + Δ t )} = \frac{{a}_{{l}_{1} , {k}_{2}}}{{a}_{{l}_{1} , {k}_{1}}} {e}^{j 2 π ( {k}_{2} - {k}_{1} ) b ( {t}_{{l}_{1}} + Δ t )}$$

FIG. 17 illustrates an example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving information about K NZP CSI-RSs and a calibration report (1710). For example, in 1710, K is a positive integer. In various embodiments, the K NZP CSI-RSs have a same BW. In various embodiments, the K NZP CSI-RSs are associated with at least one NZP CSI-RS resource set. The UE then measures the K NZP CSI-RSs based on the information (1720). The UE then determines a calibration offset for each of the K NZP CSI-RSs based on the measurement (1730). For example, in 1730,

The UE then transmits the calibration report including at least one indicator indicating the calibration offset for each of the K NZP CSI-RSs (1740). For example, in 1740, each of the K NZP CSI-RSs is associated with a CSI-RS port and The calibration offset corresponds to at least one of a DO, a FO, and a PO. In various embodiments, the CSI-RS port associated with each of the K NZP CSI-RSs has a same port index.

In various embodiments, when the calibration offset corresponds to DO or FO and each of the K NZP CSI-RSs is configured as a TRS. For example, the at least one NZP CSI-RS resource set corresponds to K NZP CSI-RS resource sets, where each of the K NZP CSI-RS resource sets include one of the K NZP CSI-RSs. In various embodiments, each of the K NZP CSI-RSs is a periodic TRS.

In various embodiments, when the calibration offset corresponds to PO, the at least one NZP CSI-RS resource set corresponds to one NZP CSI-RS resource set including the K NZP CSI-RSs, the K NZP CSI-RSs are associated with at least one sounding reference signal (SRS) with usage set to ‘AntennaSwitching’, and the UE transmits the at least one SRS.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about (i) K non-zero-power channel state information reference signals (NZP CSI-RSs), K>1, and (ii) a calibration report; and
a processor operably coupled to the transceiver, the processor configured to:
measure, based on the information, the K NZP CSI-RSs, and
determine, based on the measurement, a calibration offset for each of the K NZP CSI-RSs,
wherein the transceiver is further configured to transmit the calibration report including at least one indicator indicating the calibration offset for each of the K NZP CSI-RSs,
wherein each of the K NZP CSI-RSs is associated with a CSI-RS port, and
wherein the calibration offset corresponds to at least one of a delay offset (DO), a frequency offset (FO), and a phase offset (PO).

2. The UE of claim 1, wherein the K NZP CSI-RSs have a same bandwidth (BW).

3. The UE of claim 1, wherein the K NZP CSI-RSs are associated with at least one NZP CSI-RS resource set.

4. The UE of claim 3, wherein:
when the calibration offset corresponds to DO or FO, each of the K NZP CSI-RSs is configured as a tracking RS (TRS),
the at least one NZP CSI-RS resource set corresponds to K NZP CSI-RS resource sets, and
each of the K NZP CSI-RS resource sets includes one of the K NZP CSI-RSs.

5. The UE of claim 4, wherein each of the K NZP CSI-RSs is a periodic TRS.

6. The UE of claim 3, wherein:
when the calibration offset corresponds to PO, the at least one NZP CSI-RS resource set corresponds to one NZP CSI-RS resource set including the K NZP CSI-RSs,
the K NZP CSI-RSs are associated with at least one sounding reference signal (SRS) with usage set to ‘AntennaSwitching’, and
the transceiver is further configured to transmit the at least one SRS.

7. The UE of claim 1, wherein the CSI-RS port associated with each of the K NZP CSI-RSs has a same port index.

8. A base station (BS) comprising:
a processor; and
a transceiver operably coupled to the processor, the transceiver configured to:
transmit information about (i) K non-zero-power channel state information reference signals (NZP CSI-RSs), K>1, and (ii) a calibration report; and
receive the calibration report including at least one indicator indicating a calibration offset for each of the K NZP CSI-RSs,
wherein each of the K NZP CSI-RSs is associated with a CSI-RS port, and
wherein the calibration offset corresponds to at least one of a delay offset (DO), a frequency offset (FO), and a phase offset (PO).

9. The BS of claim 8, wherein the K NZP CSI-RSs have a same bandwidth (BW).

10. The BS of claim 8, wherein the K NZP CSI-RSs are associated with at least one NZP CSI-RS resource set.

11. The BS of claim 10, wherein:
when the calibration offset corresponds to DO or FO, each of the K NZP CSI-RSs is configured as a tracking RS (TRS),
the at least one NZP CSI-RS resource set corresponds to K NZP CSI-RS resource sets, and
each of the K NZP CSI-RS resource sets includes one of the K NZP CSI-RSs.

12. The BS of claim 11, wherein each of the K NZP CSI-RSs is a periodic TRS.

13. The BS of claim 10, wherein:
when the calibration offset corresponds to PO, the at least one NZP CSI-RS resource set corresponds to one NZP CSI-RS resource set including the K NZP CSI-RSs,
the K NZP CSI-RSs are associated with at least one sounding reference signal (SRS) with usage set to ‘AntennaSwitching’, and
the transceiver is further configured to receive the at least one SRS.

14. The BS of claim 8, wherein the CSI-RS port associated with each of the K NZP CSI-RSs has a same port index.

15. A method performed by a user equipment (UE), the method comprising:
receiving information about (i) K non-zero-power channel state information reference signals (NZP CSI-RSs), K>1, and (ii) a calibration report;
measuring, based on the information, the K NZP CSI-RSs;
determining, based on the measurement, a calibration offset for each of the K NZP CSI-RSs;
transmitting the calibration report including at least one indicator indicating the calibration offset for each of the K NZP CSI-RSs,
wherein each of the K NZP CSI-RSs is associated with a CSI-RS port, and
wherein the calibration offset corresponds to at least one of a delay offset (DO), a frequency offset (FO), and a phase offset (PO).

16. The method of claim 15, wherein the K NZP CSI-RSs have a same bandwidth (BW).

17. The method of claim 15, wherein the K NZP CSI-RSs are associated with at least one NZP CSI-RS resource set.

18. The method of claim 17, wherein:
when the calibration offset corresponds to DO or FO, each of the K NZP CSI-RSs is configured as a tracking RS (TRS),
the at least one NZP CSI-RS resource set corresponds to K NZP CSI-RS resource sets, and
each of the K NZP CSI-RS resource sets includes one of the K NZP CSI-RSs.

19. The method of claim 18, wherein each of the K NZP CSI-RSs is a periodic TRS.

20. The method of claim 17, wherein:
when the calibration offset corresponds to PO, the at least one NZP CSI-RS resource set corresponds to one NZP CSI-RS resource set including the K NZP CSI-RSs,
the K NZP CSI-RSs are associated with at least one sounding reference signal (SRS) with usage set to ‘AntennaSwitching’, and
the method further comprises transmitting the at least one SRS.
